(19) United States
(12) Patent Application Publication
(10) Pub. No.: US 2004/0059918 A1
(43) Pub. Date: Mar. 25, 2004

(54) Method and system of digital watermarking for compressed audio

(76) Inventor: Changsheng Xu, Coast Road (SG)

Correspondence Address: OSTROLENK FABER GERB & SOFFEN, 1180 AVENUE OF THE AMERICAS, NEW YORK, NY, 100368403

(21) Appl. No.: 10/450,736

(22) PCT Filed: Dec. 15, 2000
(86) PCT No.: PCT/SG00/00205

(51) Int. Cl. H04L 9/00

(52) U.S. Cl. 713/176

(57) ABSTRACT

The invention provides a system and method of rapidly embedding and extracting digital watermarks into and from digital compressed audio content. The watermark may be embedded or extracted in both compressed and uncompressed formats. While the watermark is inaudible within its host signal and extremely difficult to remove via unauthorized access, it may be easily extracted by an authorized user. The watermark is also highly resistant to incidental and intentional distortion, alteration or copying. The embedded watermark does not adversely affect the audio quality, e.g., audibility, or result in the alteration of the bit rates in a compressed domain signal and is compatible with state-of-the-art signal processing methods and phenomenon, such as D/A and A/D conversions, and the overlay of noise and electrical and magnetic interference, filtering, re-sampling, and in particular, decoding and re-encoding processes. FIG. 1 of the drawings shall accompany the publication of the abstract.

### TECHNICAL FIELD

The invention relates generally to digital watermarking for the purpose of copyright protection for authorized copies of digital multimedia content, including audio, and the tracing of illegal copies of such digitally compressed and uncompressed content.

### BACKGROUND OF THE INVENTION

Today, the pace of advancing development in Internet technology, audio coding, digital signal processing, and digital compressed audio distribution systems and methods has become increasingly rapid and more convenient. The application of compression algorithms to digital audio content permits preservation of audio quality, a dramatic reduction in bit rate, an increase in network bandwidth, and the increase an storage density of that audio content. Among various kinds of compressed digital audio currently used, MP3 is the most popular and is becoming the domain of choice for music listeners and users, such as distributors and sellers. MP3 audio compression is based on psycho-acoustic models of the human auditory system (“HAS”). It is an ideal domain for distributing high-quality sound files online because it can offer near-CD quality at a compression ratio of 11 to 1 (128 kb/s).

The open architecture environment of the Internet provides numerous opportunities for the illegal distribution of privately owned digital audio content and other multimedia products. There exists a need for copyright protection and the ability to trace the illegal distribution channels and sources to prevent digital multimedia content from being illegally distributed. Digital watermarking is one of the emerging technologies being developed to address these issues. Digital watermarking directly embeds copyright and user identification information, and indicia into original audio content and maintains the information in the audio, even after various forms of manipulation. Watermark detection is used to unambiguously identify the ownership of digital content, as well as assist in the location of illegal distribution sources. Generally, a watermark located within audio content should be inaudible and resistant to different forms of unauthorized manipulation.

However, there are very few digital watermarking techniques for compressed audio content. Presently, there are only two existing watermarking methods for use with compressed audio content. Both of these methods result in watermarks that are not particularly robust and are subject to relatively easy removal.

In U.S. Pat. No. 5,778,102 by Sandford et al., entitled “Compression Embedding,” auxiliary information is embedded as a watermark into a host signal created by a lossy compression technique. This method has a marginal ability to prevent the watermark from being removed without significantly impacting the quality of the host audio signal.

Fabien Petitcolas from Cambridge University of the United Kingdom proposed a watermarking method (MP3 Stego) for MP3 files. MP3 Stego hides information in MP3 files during the compression process. In MP3 Stego, the data is compressed, encrypted, and then hidden in the MP3 bit stream. Although MP3 Stego was written with stenographic applications in mind, it may be used as a copyright marking system for MP3 files. This results in digital content that has only a marginal robustness. The hiding process occurs at the heart of the Layer III encoding process, namely in the inner loop. The inner loop quantizes the input data and increases the quantizer step size until the quantized data can be coded with the available quantity of bits. Another loop ensures that the distortions introduced by the quantization do not exceed the threshold defined by the psychoacoustic model. The part2_{—}3_length variable, which is an MP3 domain data field, includes the number of main data bits used for scale factors and Huffman code data in the MP3 bit stream. The bits are encoded by changing the end loop condition of the inner loop. Only randomly chosen part2_{—}3_length values are modified and the selection is performed by using a pseudo random bit generator based on an Extend Secure Hash Algorithm, SHA-1. In this technique, the watermark is not directly embedded into the compressed digital content. Rather, it is embedded into pulse code modulation (PCM) audio prior to being compressed. This technique results in marginal robustness for the watermark, and allows an attacker to remove the hidden watermark information by decompressing and recompressing the bit stream.

The prior art fails to provide a manner of simultaneously copyright marking or labeling digital information, while preserving its security and without destroying or modifying the content of the information. In addition, the prior art fails to provide a satisfactory solution to prevent the illegal distribution sources of digital audio content. Accordingly, there is a need for an effective and robust digital audio watermarking technique for compressed audio content.

### SUMMARY OF THE INVENTION

An embodiment of the invention provides a method of embedding a watermark into a digitally uncompressed audio signal. The method includes segmenting an original audio signal into a plurality of frames, extracting feature parameters from each of the plurality of frames, assigning an embedding framework for each of the plurality of frames, based on the feature parameters and the masking threshold, embedding the watermark information into the audio frame, and compressing the watermarked audio signal.

Another embodiment of the invention provides a method of embedding a watermark into a compressed audio signal. The method includes segmenting a compressed audio signal into a plurality of frames, extracting the scale factors selection information (SCFI) for each of the plurality of frames, locating the position of scale factor band (SFB) for each of the plurality of frames, selecting the scale factors corresponding to high-frequency sub-bands for each of the plurality of frames, and embedding the synchronization code and the watermark information into each of the plurality of frames.

Another embodiment of the invention provides a method of embedding a watermark into a partially uncompressed domain. The method includes segmenting a compressed audio signal into a plurality of frames, decoding all the frames, extracting feature parameters from each of the decoded frames, computing a psychoacoustic model for each of the decoded frames, selecting the candidate frames suitable to embed the watermark based on the feature parameters and the masking threshold, embedding the watermark information into these selected frames, re-encoding the embedded frame, and reconstructing the embedded frames and non-embedded frames to generate the watermarked compressed audio.

Another embodiment of the invention provides a method to extract an embedded watermark from uncompressed digital audio. The method includes dividing the watermarked audio into a plurality of frames, determining a magnitude of an autocorrelation of the embedded watermark's cepastrum at a location in each of the plurality of frames, and mapping a plurality of data bits of each frame into code that may be correlated with an original watermark.

Another embodiment of the invention provides a method to extract an embedded watermark from compressed digital audio. The method includes dividing the watermarked compressed audio into a plurality of frames, locating the position of scale factor band for each of the plurality of frames, finding out the synchronization code, and detecting the watermark sequence to recover the embedded watermark.

Another embodiment of the invention provides a method to extract an embedded watermark from a partially uncompressed domain. The method includes dividing the watermarked compressed audio into a plurality of frames, decoding all the frames, extracting feature parameters from each of the decoded frames, computing a psychoacoustic model for each of the decoded frames, detecting the embedded frames based on the feature parameters and the masking threshold, and extracting the watermark.

### DESCRIPTION OF THE DRAWINGS

FIG. 1 illustrates a block diagram of an embodiment of the watermark embedding process of the invention for both the uncompressed and compressed domains.

FIG. 2 illustrates a block diagram of an embodiment of the watermark embedding process of the invention for the uncompressed domain.

FIG. 3 illustrates a block diagram of an embodiment of the watermark embedding process of the invention for the compressed domain.

FIG. 4 illustrates a block diagram of an embodiment of the watermark embedding process of the invention for the partially uncompressed domain.

FIG. 5 illustrates a block diagram of an embodiment of the watermark extraction process of the invention.

FIG. 6 illustrates a block diagram of an embodiment of the watermark extraction process of the invention for the uncompressed domain.

FIG. 7 illustrates a block diagram of an embodiment of the watermark extraction process of the invention for the compressed domain.

FIG. 8 illustrates a block diagram of an embodiment of the watermark extraction process of the invention for the partially uncompressed domain.

### DETAILED DESCRIPTION OF THE INVENTION

The invention provides an effective method and system to protect copyrighted digital audio content and trace the illegal distribution of such digitally compressed audio by embedding digital watermarks into compressed, uncompressed, and partially uncompressed domains. The resultant watermarked audio content demonstrates an excellent resistance to unauthorized removal, i.e., “robustness,” including various kinds of unauthorized manipulation. The invention prevents the embedded information from adversely affecting the audio quality, e.g., audibility, of the digital content. The watermark detection can be done either in a compressed, uncompressed, or partially uncompressed domain. A “partially uncompressed domain” refers to a domain in which only some of the frames in the compressed domain are decoded. The detected watermark information can provide indicia of both copyright marking and the source of distribution. Overall, the invention achieves an optimal balance between the audibility and the robustness of watermarked audio, so that an embedded watermark cannot be easily removed or distorted.

For copyright protection, the owner identification (“ID”) information is first embedded as a watermark into the uncompressed plain audio content prior to being compressed. Then the watermarked audio is compressed to form the compressed audio content. In this phase, the watermark information, e.g., owner ID, which is embedded in the audio content is identical and can be embedded prior to distribution. Since the watermark is directly embedded into the audio content, the watermark must be inaudible within the host audio signal. Furthermore, the watermark must also be robust in its ability to withstand alteration or removal when it is subjected to processing, especially for compression-decompression-recompression processing. In order to attain this objective, the invention utilizes a content-adaptive embedding method based on the human auditory system (“HAS”), to achieve an optimal balance between audibility and robustness. By use of the invention, the watermark is effectively related to the audio content and closely mirrors the masking threshold of the HAS. Any attempt to remove or distort the watermark, including re-encoding the audio content, will lead to perceptible distortion of the original audio content. Correspondingly, the watermark detection is performed in the uncompressed domain and may use the original content as a reference.

For tracing illegal distribution and use, the watermarked embedding and detection is performed in the compressed domain. In addition to owner ID information, the watermark information should also include user ID information. This permits the watermark content for each audio transaction to be different.

The invention utilizes a bit stream-based watermark embedding method and system. The watermark embedding of the invention results in a slightly increased data rate, but does not cause perceptible distortion in audibility. The distortion in audibility is less than 0.5%. To improve the robustness of the watermark when, for example, the watermark is removed or distorted in the compressed domain, the invention permits the conversion of watermark information from a compressed domain to a partially uncompressed domain. By doing so, the invention permits and ensures that the detection of the watermark in the uncompressed domain provides indicia of copyright marking and allows the tracing of illegal content distribution, even if the watermark in the compressed domain is distorted. Also, the invention does not adversely affect the embedding speed when the watermark is embedded on-line.

Watermark Embedding

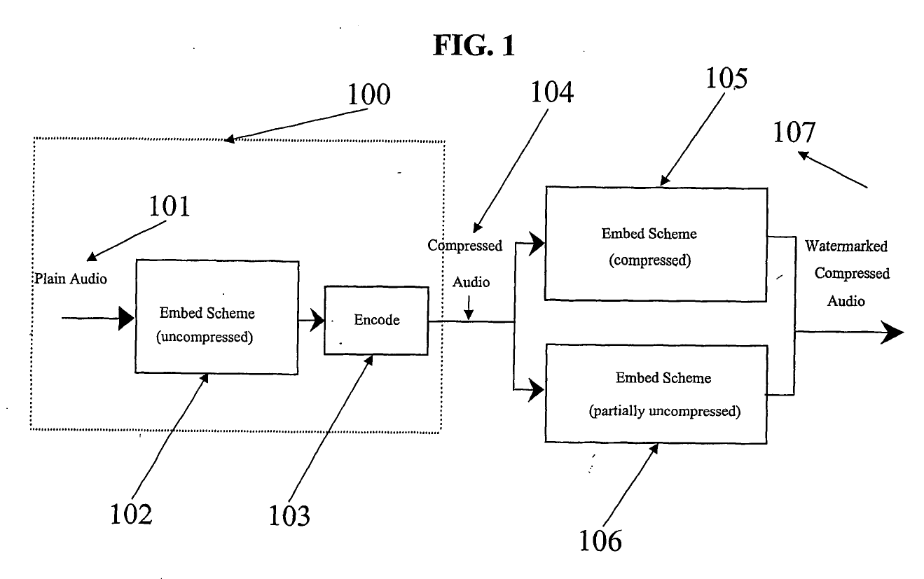

FIG. 1 illustrates the combination of the prior art's procedure of watermark embedding (the left-hand side) 100 in uncompressed domain 102, and the invention's process of embedding in a compressed domain 107 (right-hand side). Ordinarily, as in the case of plain audio (PCM) formatted content 101, a watermark is embedded prior to compression. The watermark is embedded into an uncompressed domain 102 and encoded 103 wherein the content of the watermark is in the form of, for example, copyright indicia. The watermark content that can be utilized also includes, for example, owner identification (“ID”) information and user ID information. In the invention, the watermark is embedded into the compressed audio 104 by one of two methods to produce watermarked compressed audio 107. In the first method, the watermark is directly embedded into a compressed domain 105. In the second method, the watermark is embedded into a partially uncompressed domain 106. The invention is compatible for embedding and extracting watermarks in a variety of compressed domains, such as, MP3, AC-3, a high-quality, low complexity multi-channel audio coder developed by Dolby Laboratories, MPEG-1, Layer-3 audio, and Advanced Audio Coding (AAC).

In today's marketplace, most of the compressed audio content housed within the music distribution industry's on-line music servers do not contain such watermarking indicia or information. To protect these copyrighted works and to trace their illegal distribution, while at the same time ensuring the integrity of on-line transaction, the watermark, including copyright indicia and user identification, should be embedded into this digital audio content. The invention includes several embodiments of its watermark embedding process. In one embodiment, the watermark is directly embedded into the compressed domain 105. In another embodiment, the watermark is embedded into the partially uncompressed domain 106. These embodiments provide a multi-layered protection scheme for compressed audio content. The invention permits the rapid detection of the watermark in the compressed domain, while the robustness of the watermark in the uncompressed domain is greatly improved, e.g., the capability of the watermark to resist removal or alteration. The embedded watermark in either a compressed or an uncompressed domain is inaudible, i.e., there are no appreciable differences in audibility between the original and watermarked audio content. Accordingly, the watermark is embedded into the main data field of the digital bit stream in the compressed domain, as opposed to an auxiliary data field.

Embedding Process in an Uncompressed Domain

The invention permits the embedding of a watermark into plain audio content before compression. Since the watermarked plain audio will be compressed, an audio coding process is used to ensure that the audio quality and robustness of the watermark are achieved and maintained.

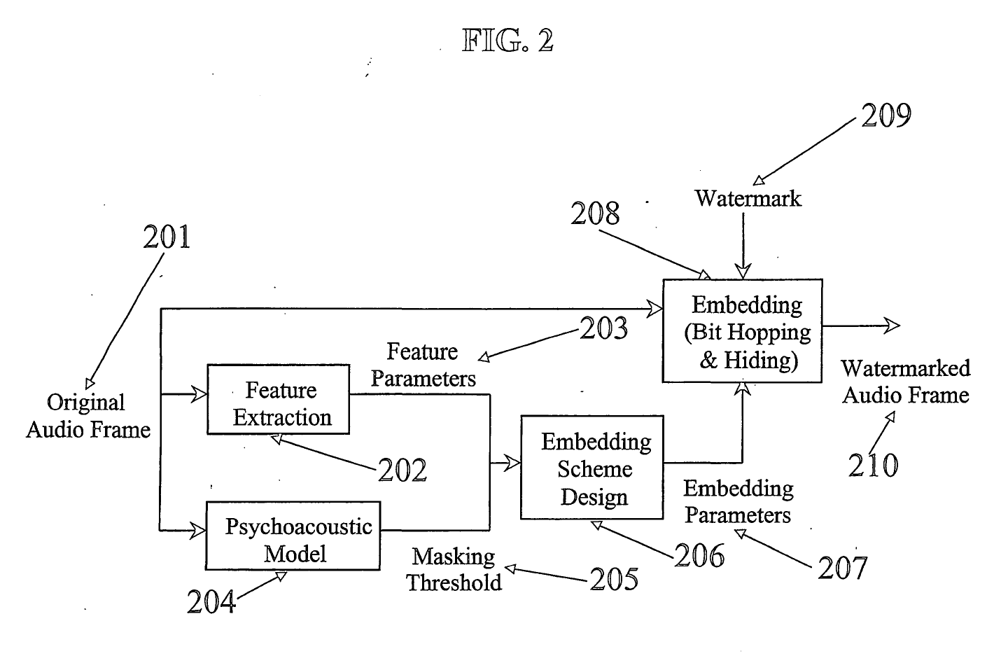

FIG. 2 illustrates an embodiment of the invention for embedding a watermark in an uncompressed digital content. Audio coding is a “lossy” process in which the quality of the compressed audio is lower than that of the original audio. Although audio coding is a lossy process, the embedded watermark must exist after audio compression. Furthermore, the embedded watermark must not adversely affect the perceived audio quality of the content. In order to ensure these requirements, the method of embedding according to the present invention fully considers the HAS's psychoacoustic model 204 and the features of the audio content. The features may include all time-domain and frequency-domain features of an audio signal such as power, loudness, brightness, bandwidth, Mel-scale, etc. The original audio signal is first segmented into a plurality of frames 202. Feature parameters 203 are extracted from each frame to represent the characteristics of the audio signal in that frame. Simultaneously, each frame passes through a psychoacoustic model 204 to determine the ratio of the signal energy to the masking threshold 205. Based on the feature parameters 203 and masking threshold 205, the embedding framework for each frame is designed 206. A watermark 209 is embedded into the audio frame using multiple bit hopping and hiding process steps 208 resulting in a watermarked audio frame 210. The watermarked audio signal is then compressed to generate the compressed audio content, i.e., audio signal.

Embedding Process in a Compressed Domain

For digital audio signals, it is difficult to embed the watermark in the compressed domain because minor modifications to the bit stream of the compressed audio may cause distortion of audio quality. To make the embedded watermark imperceptible, e.g., no adverse affect on the audibility, the nature and technique of the coding process is considered.

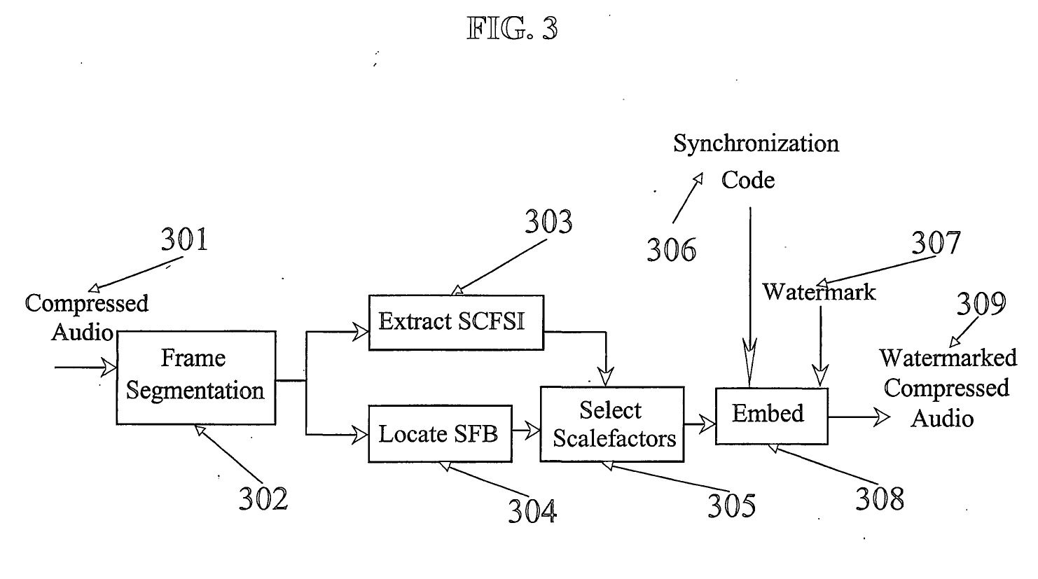

FIG. 3 illustrates an embodiment of the present invention's watermark embedding process in a compressed domain. First, the frames of compressed audio are segmented 302. For each frame, the scale factors selection information (SCFSI) is extracted 303 and the position of scale factor band (SFB) 304 is located. Then the scale factors corresponding to high frequency sub-bands are selected 305 for the embedding of the watermark. The embedding process modifies the lowest bit of the scale factors.

To make the watermark detection more precise, a synchronization code 306 is also embedded 308 into the scale factors resulting in watermarked compressed audio content 309. Preferably, the invention uses the lowest bit (orbits) of the scale factors corresponding to high frequency sub-bands, i.e., having a frequency range >10 kHz to match the watermark sequence. Therefore, it will not cause a perceptible distortion according to HAS. Since watermarks are repeatedly embedded into whole frames and the scale factors used to embed are controlled by the synchronization code 306, it is difficult for unauthorized content manipulators/users to remove the embedded watermark. If such is attempted, as in an effort to zero the lowest bits of the scale factors, an unacceptably high degree of distortion will occur upon the reconstruction of the audio content signal.

Embedding Process in a Partially Uncompressed Domain

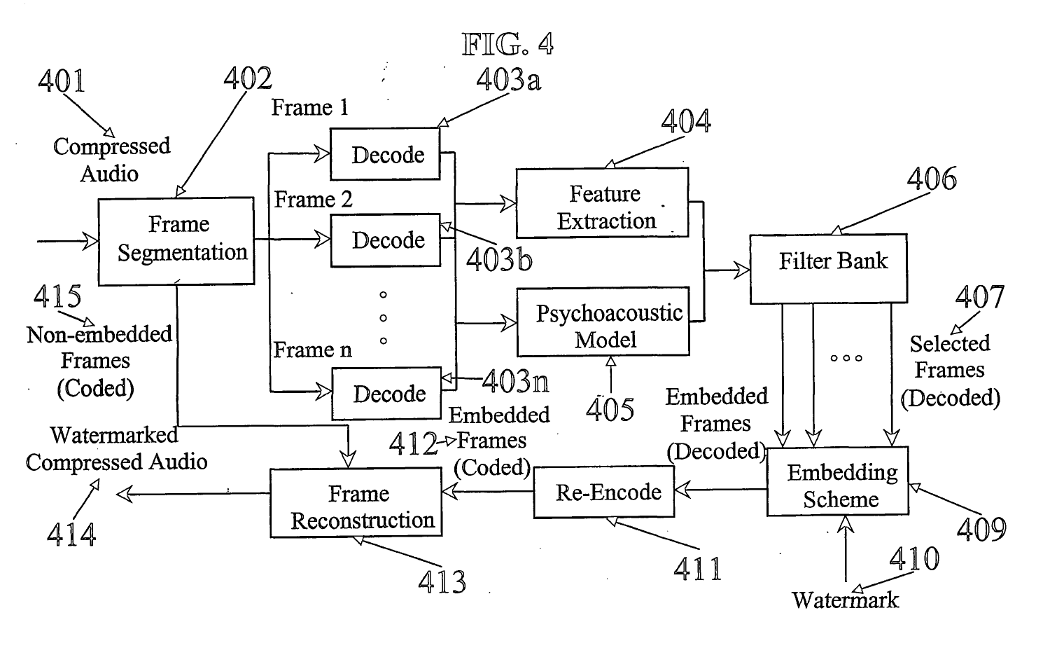

In another embodiment, which improves the robustness of the watermark, the watermark is embedded in an uncompressed domain while it is embedded in a compressed domain. The principle difference between this embodiment and the process of directly embedding a watermark into an uncompressed domain is that this embodiment permits the embedding of a watermark into a partially uncompressed domain, in addition to the decoding of the compressed audio. FIG. 4 illustrates this embodiment of the invention's watermark embedding process in a partially uncompressed domain.

The incoming compressed audio 401 is first segmented into frames 402 according to the coding process. All the frames are decoded, 403a, 403b . . . 403n, from compressed to uncompressed domain, which is similar to the uncompressed content 201 of FIG. 2. Then feature extraction 404 and the psychoacoustic model 405 are applied to each decoded frame 403a, 403b . . . 403n to analyze the characteristics of the audio content and masking threshold 205 in each frame. According to the features and masking threshold 205, a filter bank 406 is used to select the candidate frames 407 suitable to embed watermark 410. The watermark 410 is embedded into these selected frames 407 using the same embedding process 208 as in an uncompressed domain. The embedded frames will be re-encoded 411 to form the coded frames 412 using the same coding process, i.e., using a standard audio coding algorithm such as MP3 or AAC. Finally, the re-encoded frames 412 and the non-embedded frames 415 will be reconstructed 413 to generate the watermarked compressed audio content 414.

Compared with the embedded process in an uncompressed domain, this embodiment achieves, not only the same level of audibility and robustness, but also permits faster embedding of the watermark. For example, if embedding an 8-bit watermark into a five minute MP3 audio signal, the embedding time using this invention is approximately twenty seconds, while the embedding time using MP3 Stego is approximately thirty minutes. Therefore, the invention is highly suitable for digital content watermark embedding and distribution, particularly when involving on-line transactions.

Watermark Extraction Process

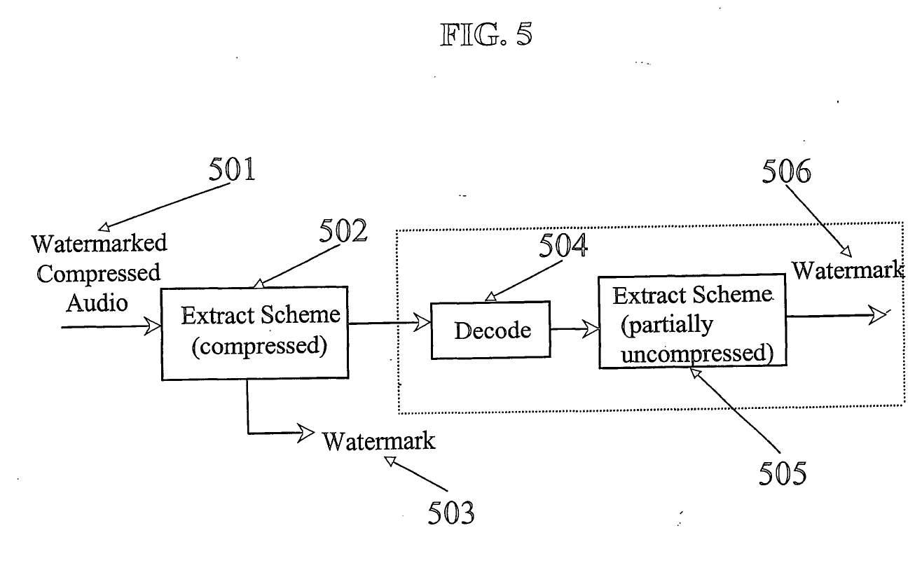

FIG. 5 illustrates another embodiment of the invention involving a generalized process of watermark extraction. For incoming watermarked compressed audio content 501, the watermark is first extracted 502 in a compressed domain. If the watermark can be detected successfully, the detection process is halted and the watermark is extracted 503. On the other hand, if the watermark cannot be detected in a compressed domain because of manipulation, alteration or unauthorized copying/use, the watermark detection is performed, including decoding 504 in a partially uncompressed domain 505, and the watermark 506 is then extracted 505.

Watermark Extraction in an Uncompressed Domain

Usually, the robustness of a watermark in the compressed domain is relatively low. Therefore, in most cases, watermark extraction in an uncompressed domain is preferred. The invention uses an extraction process to detect the watermark, wherein the watermarked compressed audio content is decoded and the embedded frames are extracted. The watermarked audio is divided into frames using the same segmentation 602 as in the embedding process 208. For each incoming frame, the magnitude of the autocorrelation of the embedded signal's cepstrum 603 is measured at relevant locations in each audio frame. From a diagram of the autocorrelation of the cepstrum, the data bits of the watermark in each frame can be detected, i.e., located, according to a “power spike” at each occurrence of a delay in the embedded bits. Through the use of multiple-bit hopping to embed the bits into the frames, the detected bits in each frame will pass through a matched filter bank 604 that can map the bits into the actual code (1 or 0). Finally, the watermark 606 is recovered 605 by correlating the detected codes with the original watermarked audio content 601.

Watermark Extraction in a Compressed Domain

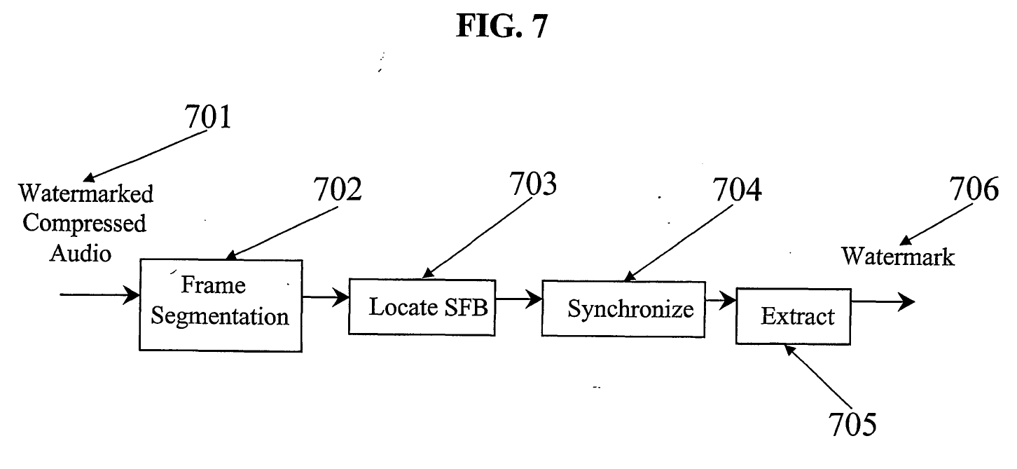

FIG. 7 illustrates an embodiment of the invention's watermark extraction in a compressed domain. The incoming watermarked compressed audio is segmented 702 into frames. The position of SFB of each frame is then located 703. In order to find the specific scale factors that are used to embed watermark bits, synchronization 704 is employed to detect the synchronization code 306. Based upon the synchronization code 306, the watermark sequence is detected and the embedded watermark 706 is extracted 705.

Watermark Extraction in a Partially Uncompressed Domain

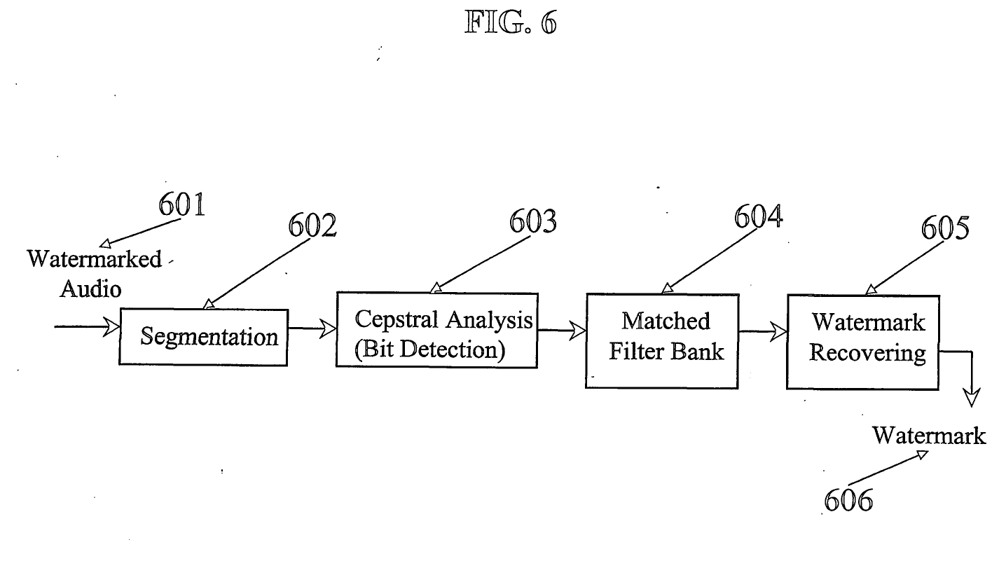

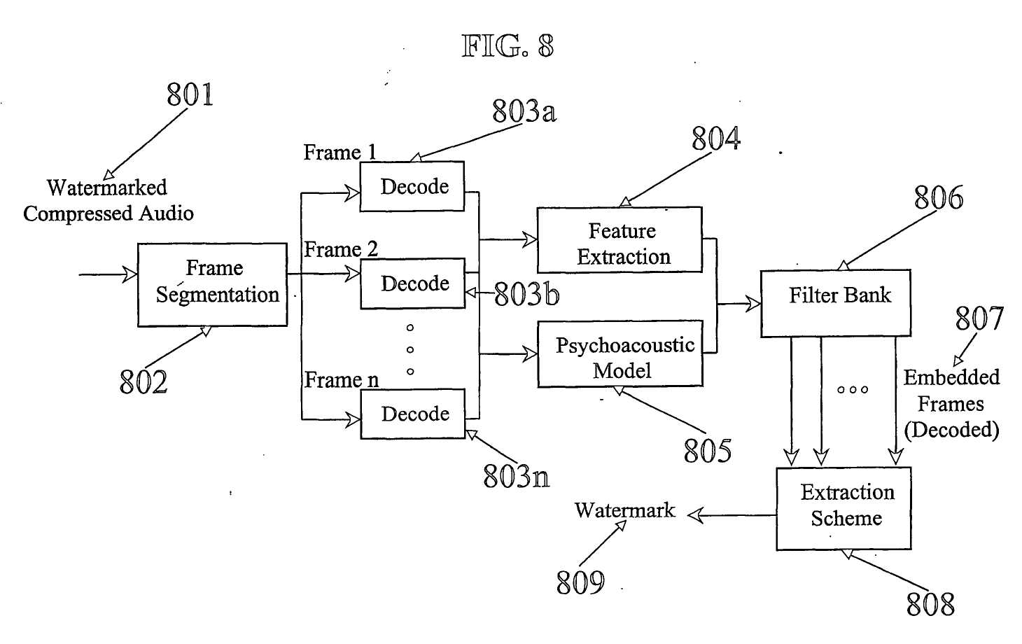

FIG. 8 illustrates another embodiment of the invention for extracting audio frames including watermarks from compressed audio content by use of partially uncompressed domain analysis. It is similar to the watermark embedding process for the partially uncompressed domain, described above. The watermarked compressed audio content 801 is first segmented 802 into frames according to a coding process. These frames are decoded 803a . . . n and each decoded frame is analyzed by feature extraction 804 and the psychoacoustic model 805. According to the calculated feature parameters 203, a filter bank 806 is applied to select the frames containing watermark information or indicia. The watermark 809 is detected from these frames using the extraction process 808, depicted in FIG. 6.

Various preferred embodiments of the invention now have been described. While these embodiments have been set forth by way of example, various other embodiments and modifications will be apparent to those skilled in the art. The invention is limited only by the appended claims and the full scope of their equivalents.

What is claimed is:

1. A method to embed a watermark in a digitally umcompressed audio signal, comprising:
segmenting an original audio signal into a plurality of frames;
extracting feature parameters from each of the plurality of frames;
assigning, based on the feature parameters and the masking threshold, an embedding framework for each of the plurality of frames,
embedding the watermark information into a watermarked audio frame; and
compressing the watermarked audio signal.

2. A method to embed a watermark in a compressed audio signal, comprising:
segmenting the compressed audio signal into a plurality of frames; extracting scale factor selection information (SCFI) for each of the plurality of frames;
locating a position of a scale factor band (SFB) for each of the plurality of frames;
selecting at least one scale factor corresponding to at least one high-frequency sub-band for each of the plurality of frames; and
embedding a synchronization code into the at least one scale factor.

3. A method to embed a watermark in a partially uncompressed domain, comprising:
segmenting a compressed audio signal into a plurality of frames;
decoding each of the plurality of frames;
extracting a feature parameter from each of the plurality of decoded frames;
computing a psychoacoustic model for each of the plurality of decoded frames;
selecting frames suitable for embedding watermark information based on the feature parameters and the masking threshold;
embedding the watermark information into the selected frame, creating an embedded frame;
re-encoding the embedded frames; and
reconstructing the embedded frames and non-embedded frames to generate a watermarked compressed audio signal.

4. A method to extract an embedded watermark from a watermarked uncompressed digital audio signal, comprising:
dividing the watermarked digital audio signal into a plurality of frames;
determining a magnitude of an autocorrelation of the embedded watermark's cepastrum at a location in each of the plurality of frames; and
mapping a plurality of data bits of each frame into code that may be correlated with an original watermark.

5. A method to extract an embedded watermark from a watermarked compressed digital audio signal, comprising:
dividing the watermarked compressed digital audio signal into a plurality of frames;
locating a scale factor band for each of the plurality of frames;
determining a synchronization code of the scale factor band for each of the plurality of frames; and
detecting a watermark sequence to recover the embedded watermark.

6. A method to extract an embedded watermark from a partially uncompressed domain, comprising:
dividing a watermarked compressed audio signal into a plurality of frames;
decoding each of the plurality of frames;
extracting feature parameters from each of the plurality of decoded frames;
computing a psychoacoustic model for each of the plurality of decoded frames;
detecting an embedded frame based on the feature parameters and the masking threshold; and
extracting the watermark.

7. A computer-readable medium including instructions to perform a method to embed a watermark into a digitally uncompressed audio signal, comprising:
a first unit to segment an original audio signal into a plurality of frames;
a second unit to extract feature parameters from each of the plurality of frames;
a third unit to assign, based on the feature parameters and the masking threshold, an embedding framework for each of the plurality of frames;
a fourth unit to embed the watermark information into the audio frame; and
a fourth unit to compress the watermarked audio signal.

8. A computer-readable medium including instructions to perform a method to embed a watermark in a compressed audio signal, comprising:
a first unit to segment the compressed audio signal into a plurality of frames;
a second unit to extract scale factor selection information (SCFI) for each of the plurality of frames;
a third unit to locate a position of a scale factor band (SFB) for each of the plurality of frames;
a fourth unit to select at least one scale factor corresponding to at least one high-frequency sub-band for each of the plurality of frames; and
a fifth unit to embed a synchronization code into the at least one scale factor.

9. A computer-readable medium including instructions to perform a method to embed a watermark in a partially uncompressed domain, comprising:
a first unit to segment a compressed audio signal into a plurality of frames;
a second unit to decode each of the plurality of frames;
a third unit to extract a feature parameter from each of the plurality of decoded frames;
a fourth unit to compute a psychoacoustic model for each of the plurality of decoded frames;
a fifth unit to select frames suitable to embed watermark information in, based on the feature parameters and the masking threshold;
a sixth unit to embed the watermark information into the selected frame, creating an embedded frame;
a seventh unit to re-encode the embedded frames; and
an eighth unit to reconstruct the embedded frames and non-embedded frames to generate a watermarked compressed audio signal.

10. A computer-readable medium including instruction to perform a method to extract an embedded watermark from a watermarked uncompressed digital audio signal, comprising:
a first unit to divide the watermarked uncompressed digital audio signal into a plurality of frames;
a second unit to determine a magnitude of an autocorrelation of the embedded watermark's cepastrum at a location in each of the plurality of frames; and
a third unit to map a plurality of data bits of each frame into code that may be correlated with an original watermark.

11. A computer-readable medium including instructions to perform a method to extract an embedded watermark from a watermarked compressed digital audio signal, comprising:
a first unit to divide the watermarked compressed digital audio signal into a plurality of frames;
a second unit to locate a scale factor band for each of the plurality of frames;
a third unit to determine a synchronization code of the scale factor band for each of the plurality of frames; and
a fourth unit to detect a watermark sequence to recover the embedded watermark.

12. A computer-readable medium including instructions to perform a method to extract an embedded watermark from a partially uncompressed domain, comprising:
a first unit to divide a watermarked compressed audio signal into a plurality of frames:
a second unit to decode each of the plurality of frames;
a fourth unit to extract feature parameters from each of the plurality of decoded frames;
a fifth unit to compute a psychoacoustic model for each of the plurality of decoded frames; and
a sixth unit to detect au embedded frame based on the feature parameters and the masking threshold; and
a seventh unit to extract the watermark.
